(19) United States
(12) Patent Application Publication
(10) Pub. No.: US 2006/0114538 A1
(43) Pub. Date: Jun. 1, 2006

(54) Light scanning device

(75) Inventor: Junichi Morooka, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/283,835

(22) Filed: Nov. 22, 2005

(30) Foreign Application Priority Data
Nov. 26, 2004 (JP) 2004-342686

(51) Int. Cl. G02B 26/08

(52) U.S. Cl. 359/196

(57) ABSTRACT

A light scanning device includes a mirror that is disposed in the light path of scan light emitted from a light source and changes the light path by reflecting the scan light. The light scanning device also includes a reinforcement member that is fixed to the mirror. The reinforcement member has a predetermined length in the light axis direction of the scan light such that the natural frequency of the mirror is set to be different from the vibrational frequency of the light scanning device.

### CROSS-REFERENCE TO RELATED APPLICATION

This application claims priority under 35 USC 119 from Japanese Patent Application No. 2004-342686, the disclosure of which is incorporated by reference herein.

### BACKGROUND OF THE INVENTION

1. Field of the Invention

The present invention relates to a light scanning device.

2. Description of the Related Art

Conventionally, scanning/exposure with a light scanning device have been commonly used in image forming apparatus such as printers and copiers. Oftentimes, because it is necessary to make the device compact, the scan light is reflected with mirrors, the outer dimension of the device is reduced while maintaining the light path length, and the scanning beam is emitted.

There are numerous parts inside the device that vibrate, such as a motor and a cooling fan, and the vibration extends to the entire device. The vibration from these parts also causes the mirrors to vibrate, which in turn causes the positional precision of the scan light to deteriorate. It is also conceivable for the vibration to cause deterioration in image quality, such as fuzziness and distortion.

Thus, as shown in FIGS. 6A and 6B, a method has been proposed where a mirror 102 is fixed to a casing and reinforced with a reinforcement member 104 whose cross section is L-shaped.

In this case, the effect of suppressing vibration is slight if the lengths of the two edges forming the L shape of the reinforcement member 104 are substantially equal. It is also necessary to fix a back side 102a of the reflective surface and a side surface 102b of the mirror 102 to the reinforcement member 104, which adversely affects the planarity of the mirror 102, and the work of adhering these also takes time and effort. Moreover, the cost of the device becomes high because high dimensional precision of the reinforcement member 104 itself is demanded.

Also, even if a method of fixing the back side 102a of the reflective surface of the mirror 102 to the reinforcement member 104 via an elastic member is adopted, adverse affects on the flatness of the mirror 102 are conceivable. If the fixing area is reduced in consideration of flatness, the rigidity of the entire mirror 102 drops; thus, there is no value in using the reinforcement member 104. That is, there is a trade-off between the rigidity and the flatness of the mirror 102, and the flatness of the mirror 102 is adversely affected if the fixing area is increased in order to raise the rigidity of the mirror 102.

A structure has also been proposed where the flatness and rigidity of the mirror are improved by fixing a planar reinforcement member to the side surface of the mirror with an adhesive or two-sided tape. However, there is little improvement in rigidity when the reinforcement member is fixed to the mirror with two-sided tape, the improvement in rigidity is insufficient when the reinforcement member is fixed to the mirror with an adhesive, and the effect of suppressing vibration is slight with a planar reinforcement member. Thus, it is difficult to suppress the vibration of the mirror.

The vibration of the mirror also includes vibration in a rotational direction, in which the mirror rotates around its center of gravity, and not flexural vibration resulting from the rigidity of the mirror itself. A structure has been proposed where this vibration in the rotational direction is suppressed by disposing a reverse-moment spindle on the mirror holder. However, with this method, a spindle with a complicated shape must be disposed, and the cost of the parts and the weight of that site end up increasing.

Additionally, although the rigidity of the entire mirror and the natural frequency of the mirror can be raised with the above configuration, the frequencies of the vibrations occurring inside and outside the device are not single but wide-ranging. Thus, it is necessary to control the natural frequency of the mirror in order to avoid resonance of the mirror.

### SUMMARY OF THE INVENTION

The present invention has been made in view of above circumstances and provides a light scanning device.

A light scanning device of a first aspect of the invention comprises: a light source that emits scan light; a mirror that is disposed in the light path of the scan light emitted from the light source and changes the light path by reflecting the scan light; and a reinforcement member that is fixed to the mirror, wherein the reinforcement member has a predetermined length in the light axis direction of the scan light such that the natural frequency of the mirror is different from the vibrational frequency of the light scanning device.

A light scanning device of a second aspect of the invention comprises: a light source that emits light for scanning; and a scanning unit that scans, on a predetermined scanned surface, the light emitted from the light source, the scanning unit including a reflector that is disposed in the light path of the scan light, with the reflector including a mirror that includes a reflective surface which changes the light path by reflecting the light and a reinforcement member fixed to the mirror, wherein the reinforcement member includes a first portion that extends in a direction substantially perpendicular to the reflective surface and a second portion that extends substantially parallel to the reflective surface rearward of the reflective surface in relation to the light path, with the first portion including a sufficient length in the direction perpendicular to the reflective surface such that the reflector has a natural frequency different from that of the light scanning device.

A light scanning device of a third aspect of the invention comprises: a light source that emits light; a reflective mirror that reflects, and changes the direction of, the light emitted from the light source; and a reinforcement member that is fixed to at least two sides of the reflective mirror, wherein the length of the reinforcement member in the light axis direction is adjusted such that the natural frequency of the reflective mirror is different form the vibrational frequency inside the light scanning device.

### BRIEF DESCRIPTION OF THE DRAWINGS

Embodiments of the present invention will be described in detail based on the following figures, wherein:

FIG. 1 is a cross-sectional view showing a light scanning device pertaining to a first embodiment of the invention;

FIG. 2A is a perspective view, and FIG. 2B is a cross-sectional view, showing a mirror retention mechanism in the light scanning device pertaining to the first embodiment of the invention;

FIG. 3 is a cross-sectional view showing a mirror retention mechanism in a light scanning device pertaining to a third embodiment of the invention;

FIG. 4A is a cross-sectional view, and FIG. 4B is a perspective view, showing a mirror retention mechanism in a light scanning device pertaining to a fourth embodiment of the invention;

FIG. 5 is a graph showing the effects of a mirror reinforcement member pertaining to the first embodiment of the invention; and

FIGS. 6A and 6B are diagrams showing a mirror retention mechanism in a conventional light scanning device.

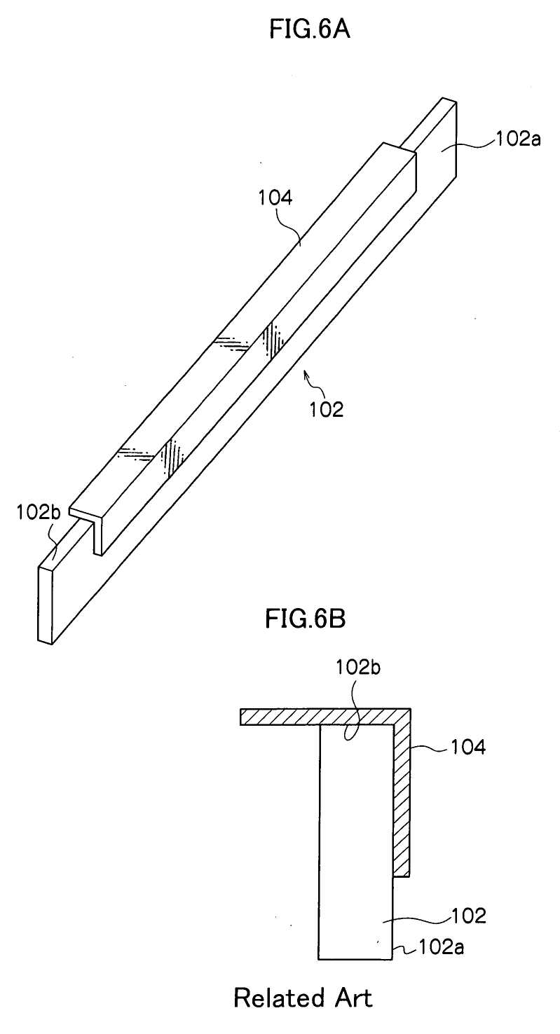

### DETAILED DESCRIPTION OF THE INVENTION

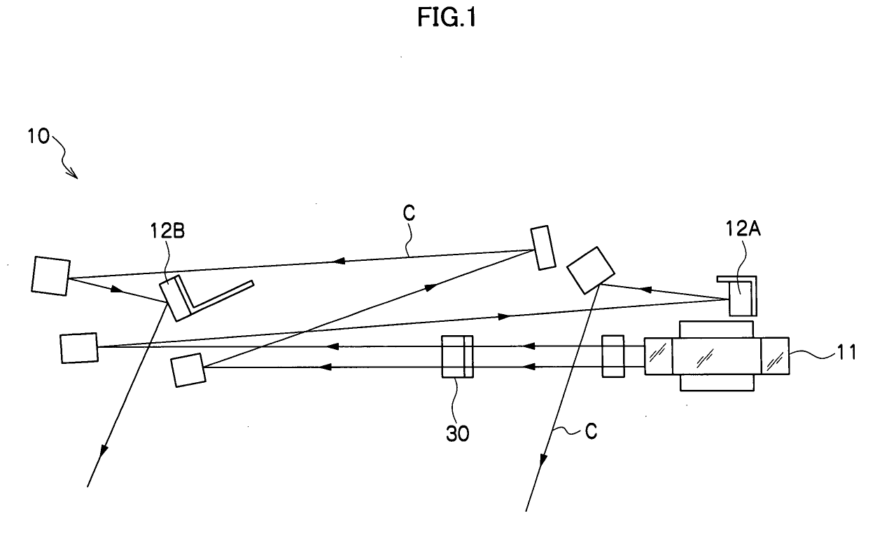

FIG. 1 shows a light scanning device 10 pertaining to a first embodiment of the invention.

As shown in FIG. 1, the light scanning device 10 includes a polygon mirror 11, mirror assemblies (reflectors) 12A and 12B, and an fθ lens 30. Light beams C deflected by the polygon mirror 11 are reflected by plural mirrors including the mirror assemblies 12A and 12B and guided to unillustrated photoreceptors to conduct exposure and image formation.

The light beams C are emitted from an unillustrated light source, deflected by the polygon mirror 11, faired by the fθ lens 30 as the light beams C, which are scanned in a main scanning direction, reflected by the plural mirrors including the mirror assemblies 12A and 12B in order to make the entire light scanning device 10 compact, and imaged on a scanned surface. Because the light beams C are reflected by the plural mirrors as described above, the entire light scanning device 10 can be made compact, but it is necessary to strictly adjust/maintain the light axis direction and planarity of each mirror.

A number of different vibration sources are present inside and outside the light scanning device 10, such as a drive motor (not shown) and drive force transmitting mechanism for the polygon mirror 11, a cooling fan, a drive device for the photoreceptors, and a drive system for photosensitive material. Resonance occurs when the natural frequencies of the mirrors match the vibrational frequencies of these vibration sources, which adversely affects the quality of the image to be recorded. Thus, it is necessary to minimize as much as possible the vibration of the mirrors and to adjust the natural frequencies of the mirrors to values that are different from the frequencies of the vibration sources inside and outside the light scanning device 10.

Also, because the frequencies of the vibration sources inside and outside the light scanning device 10 are understood to be mainly low frequencies, it is desirable to shift the natural frequencies of the mirrors to a higher level in order to prevent resonance.

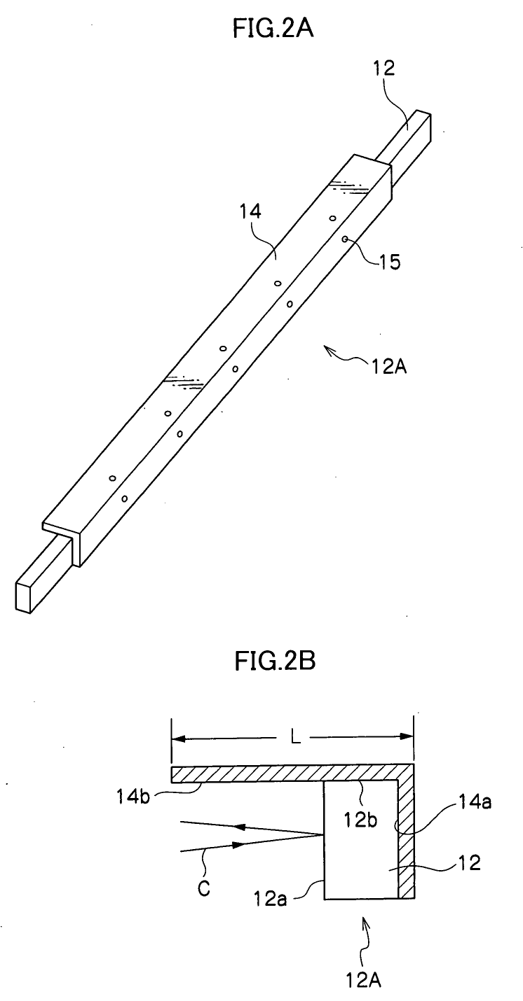

FIGS. 2A and 2B show a mirror retention mechanism in the light scanning device 10 pertaining to the first embodiment of the invention.

As shown in FIGS. 2A and 2B, the mirror assembly 12A includes a mirror 12 that is reinforced and supported by a reinforcement member 14 whose cross section is substantially L-shaped.

The reinforcement member 14 includes a support surface 14a, which is adhered to and supports the back side of a reflective surface 12a of the mirror 12, and a support surface 14b, which is adhered to and supports a side surface 12b of the mirror 12. The support surface 14b almost completely covers the side surface 12b of the mirror 12 and has a length L that extends beyond the length of the mirror 12 in the light axis direction.

Table 1 shows variations in the natural frequency of the mirror assembly 12A resulting from changes in the length L of the support surface 14b. The natural frequency of the mirror assembly 12A becomes higher when the reinforcement member 14 is extended to have a length L of 10 mm and 15 mm, in comparison to when the reinforcement member 14 does not include an extension portion, and when the number of points of adherence between the reinforcement member 14 and the mirror 12 is large.

TABLE 1

| | Mode (when light | | | | | | | | |
|---|---|---|---|---|---|---|---|---|---|
| | scanning device is | | | | | | | | |
| | assembled) | | Frequency Response Peak (Resonance Point) | | | | | | Level |
| | No extension portion | | | 176 Hz | | | | | 30.1 dBA |
| Resonance | L-shaped | 2 points of | | | 202 Hz | | | | 22 dBA |
| Frequency | sheet | adherence on | | | | | | | |
| Shift | metal | upper surface | | | | | | | |
| | (L = 10 mm) | 3 points of | | | | 220.6 Hz | | | 30 dBA |
| | | adherence on | | | | | | | |
| | | upper surface | | | | | | | |
| | | 5 points of | | | | 220.6 Hz | | | 26 dBA |
| | | adherence on | | | | | | | |
| | | upper surface | | | | | | | |
| | | 5 points of | | | | | 237.5 Hz | | 30 dBA |
| | | adherence on | | | | | | | |
| | | upper surface + 2 | | | | | | | |
| | | points of | | | | | | | |
| | | adherence on | | | | | | | |
| | | back side | | | | | | | |
| | L-shaped | 2 points of | | | | 228 Hz | | | 28 dBA |
| | sheet | adherence on | | | | | | | |
| | metal | upper surface | | | | | | | |
| | (L = 15 mm) | 3 points of | | | | | | 275 Hz | 29 dBA |
| | | adherence on | | | | | | | |
| | | upper surface | | | | | | | |
| | | 5 points of | | | | | | 277.5 Hz | 27 dBA |
| | | adherence on | | | | | | | |
| | | upper surface | | | | | | | |
| | | 5 points of | | | | | | 280 Hz | 25 dBA |
| | | adherence on | | | | | | | |
| | | upper surface + 2 | | | | | | | |
| | | points of | | | | | | | |
| | | adherence on | | | | | | | |
| | | back side | | | | | | | |
| | Spindle | Center | 154 Hz | | | | | | 37 dBA |
| | on mirror | spindle (7.6 g) | | | | | | | |
| | (for | Sheet metal | 140 Hz | | | | | | 23 dBA |
| | reference) | (1.2 mm) | | | | | | | |
| | | Back-adhered | | | | | | | |
| | | (two-sided | | | | | | | |
| | | tape) | | | | | | | |

It is thought that the reason the natural frequency becomes higher is not because of an increase in weight but because the rigidity of the entire mirror assembly 12A rises. For the purpose of reference, the natural frequency becomes lower than nominal when a spindle is disposed on the mirror 12.

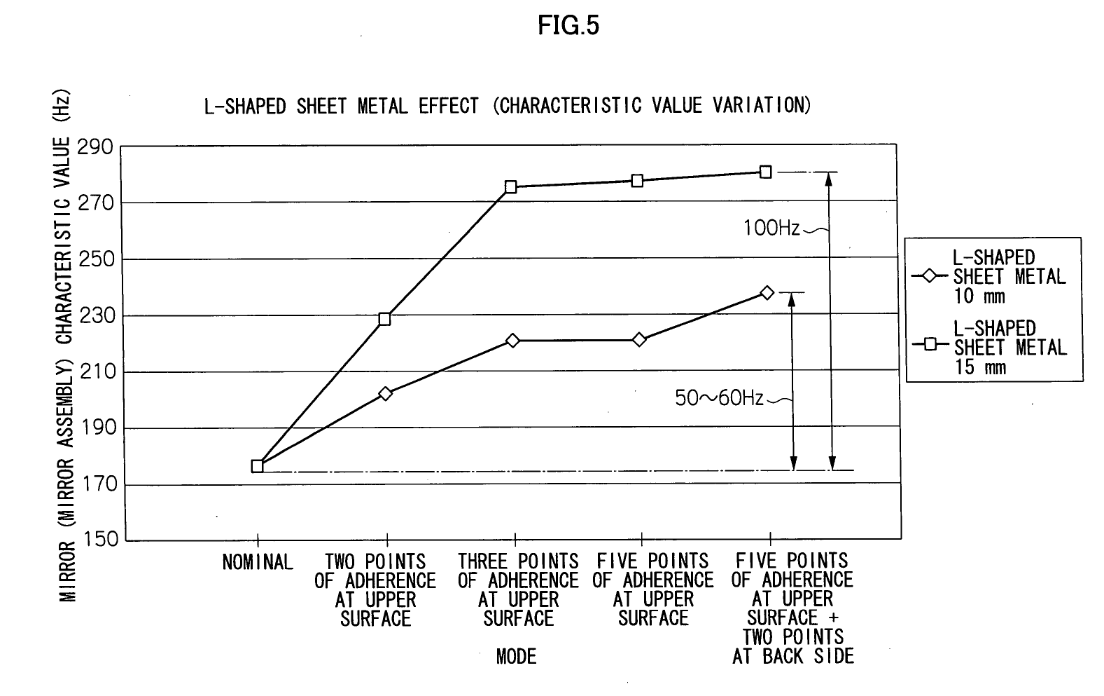

FIG. 5 is a graph showing changes in the natural frequency of the mirror assembly 12A resulting from the number of points of adherence per L value (10 mm, 15 mm) in this case. It will be understood that, as shown in FIG. 5, there is little improvement in effect with both 10 mm and 15 mm when there are more than three points of adherence on the upper surface (side surface), and that efficiency is greatest when there are three points of adherence. It will also be understood that when the length L of the reinforcement member 14 is 10 mm, the shift in the natural frequency is about 50 to 60 Hz, but when the length L of the reinforcement member 14 is 15 mm, the natural frequency can be raised about 100 Hz. Thus, by adjusting the value of L, the natural frequency can be easily shifted to a desired frequency.

Also, although the reinforcement member 14 may be fixed to the mirror 12 with two-sided tape or the like, the reinforcement member 14 may also be fixed to the mirror 12 by disposing holes 15 in the reinforcement member 14 and pouring an adhesive such as UV-curable resin into the holes 15.

A second embodiment of the invention will now be described with reference to FIGS. 2A and 2B.

The reinforcement member 14 in the light scanning device 10 pertaining to the second embodiment of the invention is adhered only at the side surface 12b of the mirror 12, so that in this case, it is only the support surface 14b that supports the mirror 12. The support surface 14b almost completely covers the side surface 12b of the mirror 12 and has a length L that extends beyond the length of the mirror 12 in the light axis direction.

By structuring the light scanning device 10 in this manner, a sufficient effect (high rigidity) may be obtained even if the reinforcement member 14 is fixed to only one side—the side surface—of the mirror 12, and adverse affects on the flatness of the mirror 12 can be suppressed because the reinforcement member 14 is fixed to only the side surface of the mirror 12.

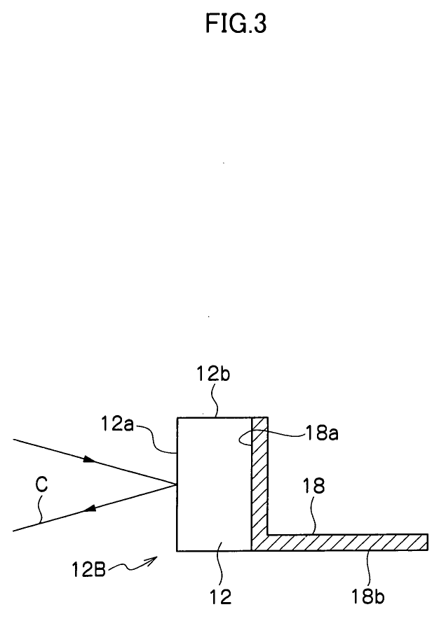

FIG. 3 shows a mirror reinforcement member 18 in the light scanning device 10 pertaining to a third embodiment of the invention.

As shown in FIG. 3, the reinforcement member 18 includes a support surface 18a, which is adhered to and supports the back side of the reflective surface 12a of the mirror 12, and an extension portion 18b, which extends in the opposite direction of the reflective surface 12a at a substantially right angle (in the substantial light axis direction) to the support surface 18a.

The reinforcement member 18 is adhered to the mirror 12 only at the support surface 18a, and the extension portion 18b is disposed as a strengthening member that raises the strength (rigidity) of the reinforcement member 18. By disposing the extension portion 18b, the rigidity of the entire mirror assembly 12B can be raised and the resonance frequency can be raised, as shown in Table 2.

TABLE 2

| | Mode (when light | | | | | | |
|---|---|---|---|---|---|---|---|
| | scanning device is | | Frequency Response Peak | | | | |
| | assembled) | | (Resonance Point) | | | | Level |
| | No extension portion | | — | 155 Hz | | | 28 dBA |
| Resonance | L-shaped | Two-sided | | | 240 Hz | | 35 dBA |
| Frequency | sheet | tape on | | | | | |
| Shift | metal | entire | | | | | |
| | (L = 15 mm) | surface | | | | | |
| | | 3 points of adherence | | | 240 Hz | | 39 dBA |
| | | on back side | | | | | |
| | L-shaped | Two-sided | | | | 265 Hz | 35 dBA |
| | sheet | tape on | | | | | |
| | metal | entire | | | | | |
| | (L = 18 mm) | surface | | | | | |
| | | 5 points of adherence | | | | 282 Hz | 27 dBA |
| | | on back side | | | | | |

Also, because the extension portion 18b is disposed on the opposite side (direction) of the reflective surface 12a, it does not interfere with the light beams C, and its size may be freely set.

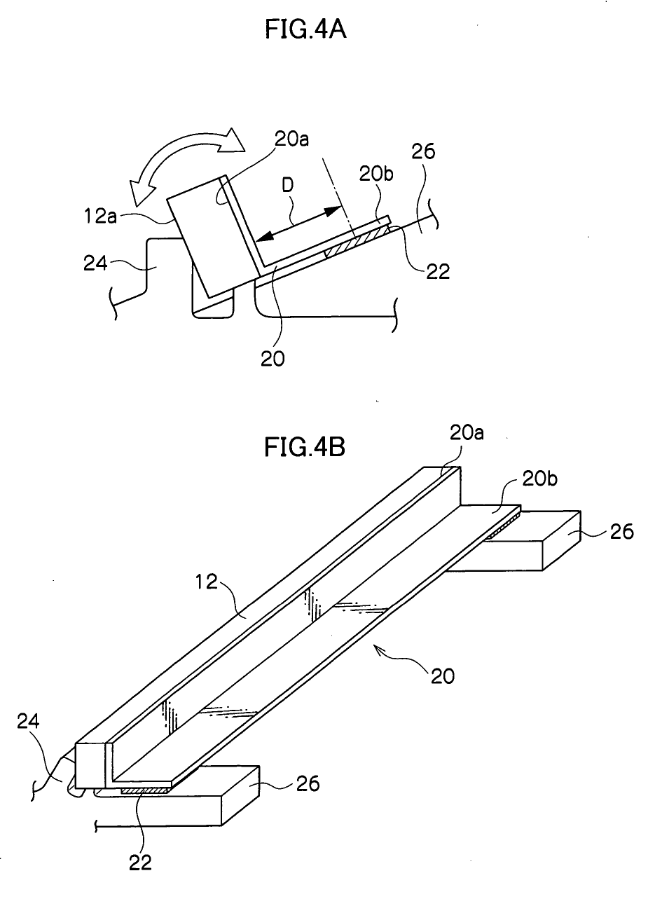

FIG. 4A shows a mirror reinforcement member 20 in the light scanning device 10 pertaining to a fourth embodiment of the invention.

As shown in FIG. 4A, the mirror reinforcement member 20 includes a support surface 20a, which is adhered to and supports the back side of the reflective surface of the mirror 12a, and an extension portion 20b, which extends in the opposite direction of the reflective surface 12a at a substantially right angle (in the substantial light axis direction) to the support surface 20a.

The extension portion 20b is also fixed, via an elastic member 22 such as a sponge, to a frame 26 at a place separated a distance D from the back side of the support surface 20a. The mirror 12 is fixed by a fixing member 24, and the extension portion 20b of the reinforcement member 20 is fixed, whereby the following effects are imparted.

That is, as shown in Table 3, a resonance frequency peak, which cannot be eliminated even if a cross-sectionally L-shaped reinforcement member is disposed, is present in the vicinity of 200 Hz, but this is thought to be vibration in the rotational direction in which the mirror 12 rotates (the white arrow in FIG. 4A) and not flexural vibration resulting from insufficient rigidity of the mirror 12.

TABLE 3

| | Mode (when light | | | | | | |
|---|---|---|---|---|---|---|---|
| | scanning device is | | Frequency Response | | | | |
| | assembled) | | Peak (Resonance Point) | | | | Level |
| | No extension portion | | 155 Hz | 202.5 Hz/ | | | 28 dBA |
| | | | | 17 dBA | | | |
| Resonance | L-shaped | Two-sided | | 202.5 Hz/ | 240 Hz | | 35 dBA |
| Frequency | sheet | tape on | | 17 dBA | | | |
| Shift | metal | entire | | | | | |
| | (L = 15 mm) | surface | | | | | |
| | | 3 points | | 202.5 Hz/ | 240 Hz | | 39 dBA |
| | | of | | 19 dBA | | | |
| | | adherence | | | | | |
| | | on back | | | | | |
| | | side | | | | | |
| | L-shaped | Two-sided | | 202.5 Hz/ | | 265 Hz | 35 dBA |
| | sheet | tape on | | 18 dBA | | | |
| | metal | entire | | | | | |
| | (L = 18 mm) | surface | | | | | |
| | | 5 points | | 202.5 Hz/ | | 265 Hz | 25 dBA |
| | | of | | 22 dBA | | | |
| | | adherence | | | | | |
| | | on back | | | | | |
| | | side | | | | | |
| | L-shaped | Two-sided | | 202.5 Hz/ | | 270 Hz | 23 dBA |
| | sheet | tape | | 0 dBA | | | |
| | metal | | | | | | |
| | (L = 18 mm) + | | | | | | |
| | sponge | | | | | | |

In order to eliminate this, it is necessary to suppress the rotational moment of the mirror 12, but in the present embodiment, the mirror 12 is fixed, via the elastic member 22, at a place distanced from the rotational (vibrational) center of the mirror 12.

Thus, vibration in the rotational direction of the mirror 12 is significantly suppressed, and as shown in Table 3, the peak of 202.5 Hz, which could not be eliminated with a cross-sectionally L-shaped reinforcement member, may be significantly reduced.

Also, as shown in FIG. 4B, by configuring the light scanning device such that the reinforcement member 20 is fixed by the elastic members 22 at both end portions in the length direction of the reinforcement member 20, the present embodiment may be adopted even in a structure where the center portion in the length direction of the mirror 12 cannot be accessed.

In the preceding embodiments pertaining to the invention, examples were described where the reinforcement members were cross-sectionally L-shaped, but the invention is not limited to this. A reinforcement member whose cross section is T-shaped or X-shaped may also be used.

The invention has been described above on the basis of specific embodiments, but the invention should not be construed as being limited to these embodiments.

That is, a light scanning device of a first aspect of the invention comprises: a light source that emits scan light; a mirror that is disposed in the light path of the scan light emitted from the light source and changes the light path by reflecting the scan light; and a reinforcement member that is fixed to the mirror, wherein the reinforcement member has a predetermined length in the light axis direction of the scan light such that the natural frequency of the mirror is different from the vibrational frequency of the light scanning device.

In the invention with this configuration, the natural frequency of the mirror may be easily controlled by changing the length of the reinforcement member in the light axis direction while maintaining the flatness and rigidity of the reflective mirror with the reinforcement member whose cross section is substantially L-shaped, and resonance of the mirror may be prevented by ensuring that the natural frequency of the mirror does not match the vibrational frequency inside the device affecting the mirror.

In this aspect, the cross section of the reinforcement member may be substantially L-shaped, and the length of the reinforcement member in the light axis direction may be longer than the length (of the surface) orthogonal thereto and longer than the length of the reflective mirror in the light axis direction.

Due to this configuration, the flexural rigidity of the mirror in the light axis direction is increased as the result of increasing the length of the reinforcement member in the light axis direction, and the natural frequency of the mirror may be raised.

In the light scanning device of this aspect, a portion of the reinforcement member along the light axis direction may be disposed facing the side of the mirror at which the light is made incident.

According to this configuration, the length of the reinforcement member in the light axis direction may be ensured without hindering the degree of freedom with which the mirror is fixed.

In the light scanning device of this aspect, the reinforcement member may be fixed just to the side surface (one side) of the mirror orthogonal to the reflective surface of the mirror.

Due to this configuration, a sufficient effect (rigidity) may be obtained even if the reinforcement member is fixed to only the one side surface of the mirror orthogonal to the reflective surface of the mirror.

The light scanning device of this aspect may also be configured such that a portion of the reinforcement member along the light axis direction is disposed at the back side of the reflective mirror.

Due to this configuration, the length of the reinforcement member in the light axis direction may be ensured without interfering with the light axis of the mirror.

In the light scanning device of this aspect, a portion of the reinforcement member along the light axis direction may be fixed to the device via an elastic member.

Due to this configuration, a portion of the reinforcement member along the light axis direction is fixed to the device via the elastic member, whereby vibration in the rotational direction of the entire mirror, and not flexural vibration, may be reduced.

Also, in the light scanning device, a portion of the reinforcement member along the light axis direction may be adhered to the reflective mirror, and the portion orthogonal to the light axis direction may be fixed to the device via an elastic member.

In this configuration, the portion orthogonal to the light axis is fixed to the device via an elastic member, whereby vibration in the rotational direction of the entire mirror, and not flexural vibration, may be reduced.

The reinforcement member may be made of metal.

Due to this configuration, the cost of the device may be prevented from increasing, while maintaining an appropriate weight and excellent workability and precision.

Because the present invention is configured as described above, it may provide a light scanning device that may prevent vibration inside the device and resonance of the mirror by controlling the natural frequency of the mirror with a reinforcement member.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A light scanning device comprising:
a light source that emits scan light;
a mirror that is disposed in the light path of the scan light emitted from the light source and changes the light path by reflecting the scan light; and
a reinforcement member that is fixed to the mirror,
wherein the reinforcement member has a predetermined length in the light axis direction of the scan light such that the natural frequency of the mirror is different from the vibrational frequency of the light scanning device.

2. The light scanning device of claim 1, wherein the natural frequency of the mirror is higher than the vibrational frequency of the light scanning device.

3. The light scanning device of claim 1, wherein the mirror has a substantially rectangular cross section orthogonal to a reflective surface that reflects the scan light, and the reinforcement member is fixed to at least one of a back side of the mirror at the opposite side of the reflective surface and one side surface of the mirror orthogonal to the back side of the mirror.

4. The light scanning device of claim 1, wherein the reinforcement member has a substantially L-shaped cross section parallel to the light axis, and one edge of the cross section is disposed along the light axis.

5. The light scanning device of claim 1, wherein the length of the edge of the reinforcement member along the light path is longer than the length of the edge orthogonal to the edge along the light path and is longer than the length of the mirror in the light axis direction.

6. The light scanning device of claim 1, wherein the edge of the reinforcement member along the light axis is disposed at the side of the mirror at which the scan light is made incident.

7. The light scanning device of claim 1, wherein the reinforcement member is fixed only to the side of the mirror orthogonal to the reflective surface that reflects the scan light.

8. The light scanning device of claim 1, wherein the edge of the reinforcement member along the light axis is disposed at the opposite side of the reflective surface of the mirror.

9. The light scanning device of claim 1, wherein the edge of the reinforcement member along the light axis is fixed to the device via an elastic member.

10. The light scanning device of claim 1, wherein the reinforcement member is made of metal.

11. A light scanning device comprising:
a light source that emits light for scanning; and
a scanning unit that scans, on a predetermined scanned surface, the light emitted from the light source, the scanning unit including a reflector that is disposed in the light path of the scan light, with the reflector including a mirror that includes a reflective surface which changes the light path by reflecting the light and a reinforcement member fixed to the mirror,
wherein the reinforcement member includes a first portion that extends in a direction substantially perpendicular to the reflective surface and a second portion that extends substantially parallel to the reflective surface rearward of the reflective surface in relation to the light path, with the first portion including a sufficient length in the direction substantially perpendicular to the reflective surface such that the reflector has a natural frequency different from that of the light scanning device.

12. The light scanning device of claim 11, wherein the natural frequency of the reflector is higher than the vibrational frequency of the light scanning device.

13. The light scanning device of claim 11, wherein
the mirror has a substantially rectangular cross section in a direction perpendicular to the reflective surface,
the first portion of the reinforcement member provides to the mirror an outer surface substantially perpendicular to the reflective surface,
the second portion of the reinforcement member provides to the mirror an outer surface substantially parallel to the reflective surface, and
the reinforcement member is fixed to the mirror at at least one of the outer surfaces.

14. The light scanning device of claim 11, wherein the length of the first portion in the direction perpendicular to the reflective surface is greater than the length of the second portion in the direction perpendicular to the outer surface of the first portion and greater than the length of the mirror in the direction perpendicular to the reflective surface.

15. The light scanning device of claim 11, wherein the first portion is formed such that it extends forward of the reflective surface.

16. The light scanning device of claim 11, wherein the first portion is formed such that it extends rearward of the reflective surface.

17. A light scanning device comprising:
a light source that emits light;
a reflective mirror that reflects, and changes the direction of, the light emitted from the light source; and
a reinforcement member that is fixed to at least two sides of the reflective mirror,
wherein the length of the reinforcement member in the light axis direction is adjusted such that the natural frequency of the reflective mirror is different form the vibrational frequency inside the light scanning device.
